(19) United States
(12) Patent Application Publication
(10) Pub. No.: US 2005/0089213 A1
(43) Pub. Date: Apr. 28, 2005

(54) Method and apparatus for three-dimensional modeling via an image mosaic system

(76) Inventor: Z. Jason Geng, Rockville, MD (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/973,853

(22) Filed: Oct. 25, 2004

Related U.S. Application Data
(60) Provisional application No. 60/514,150, filed on Oct. 23, 2003.

(51) Int. Cl. G06K 9/00

(52) U.S. Cl. 382/154

(57) ABSTRACT

An imaging method and system for 3D modeling of a 3D surface forms a mosaic from multiple uncalibrated 3D images, without relying on camera position data to merge the 3D images. The system forms the 3D model by merging two 3D images to form a mosaiced image, merging the mosaiced image with another 3D image, and repeating the merging process with new 3D images one by one until the 3D model is complete. The images are aligned in a common coordinate system via spatial transformation.

### RELATED APPLICATIONS

The present application claims priority under 35 U.S.C. § 119(e) from the following previously-filed Provisional Patent Application, U.S. Application No. 60/514,150, filed Oct. 23, 2003 by Geng, entitled “Method and Apparatus for Three-Dimensional Modeling Via an Image Mosaic System” which is incorporated herein by reference in its entirety.

### FIELD

The present system and method is directed to a system for three-dimensional (3D) image processing, and more particularly to a system that generates 3D models using a 3D mosaic method.

### BACKGROUND

Three-dimensional (3D) modeling of physical objects and environments is used in many scientific and engineering tasks. Generally, a 3D model is an electronically generated image constructed from geometric primitives that, when considered together, describes the surface/volume of a 3D object or a 3D scene made of several objects. 3D imaging systems that can acquire full-frame 3D surface images of physical objects are currently available. However, most physical objects self-occlude and no single view 3D image suffices to describe the entire surface of a 3D object. Multiple 3D images of the same object or scene from various viewpoints have to be taken and integrated in order to obtain a complete 3D model of the 3D object or scene. This process is known as “mosaicing” because the various 3D images are combined together to form an image mosaic to generate the complete 3D model.

Currently known 3D modeling systems have several drawbacks. Existing systems require knowledge of the camera's position and orientation at which each 3D image was taken, making the system impossible to use with hand-held cameras or in other contexts where precise positional information for the camera is not available. Current systems cannot automatically generate a complete 3D model from 3D images without significant user intervention.

### SUMMARY

According to one exemplary embodiment, the present system and method are configured for modeling a 3D surface by obtaining a plurality of uncalibrated 3D images (i.e., 3D images that do not have camera position information), automatically aligning the uncalibrated 3D images into a similar coordinate system, and merging the 3D images into a single geometric model. The present system and method may also, according to one exemplary embodiment, overlay a 2D texture/color overlay on a completed 3D model to provide a more realistic representation of the object being modeled. Further, the present system and method, according to one exemplary embodiment, compresses the 3D model to allow data corresponding to the 3D model to be loaded and stored more efficiently.

### BRIEF DESCRIPTION OF THE DRAWINGS

The accompanying drawings illustrate various embodiments of the present system and method and are a part of the specification. Together with the following description, the drawings demonstrate and explain the principles of the present system and method. The illustrated embodiments are examples of the present system and method and do not limit the scope thereof.

FIG. 1A is a representative block diagram of a 3D modeling system according to one exemplary embodiment.

FIG. 1B is a simple block diagram illustrating the system interaction components of the modeling system illustrated in FIG. 1A, according to one exemplary embodiment.

FIG. 2 is a flowchart illustrating a 3D image modeling method incorporating an image mosaic system, according to one exemplary embodiment.

FIG. 3 is a flowchart illustrating an alignment process incorporated by the image mosaic system, according to one exemplary embodiment.

FIGS. 4 and 5 are diagrams illustrating an image alignment process, according to one exemplary embodiment.

FIG. 6 is a flowchart illustrating an image merging process, according to one exemplary embodiment.

FIGS. 7 and 8 are representative diagrams illustrating a merging process as applied to a plurality of images, according to one exemplary embodiment.

FIG. 9 is a 3D surface image illustrating one way in which 3D model data can be compressed, according to one exemplary embodiment.

FIG. 10 is a simple block diagram illustrating a pin-hole model used for image registration, according to one exemplary embodiment.

FIG. 11 is a flow chart illustrating a registration method according to one exemplary embodiment.

Throughout the drawings, identical reference numbers designate similar, but not necessarily identical, elements.

### DETAILED DESCRIPTION

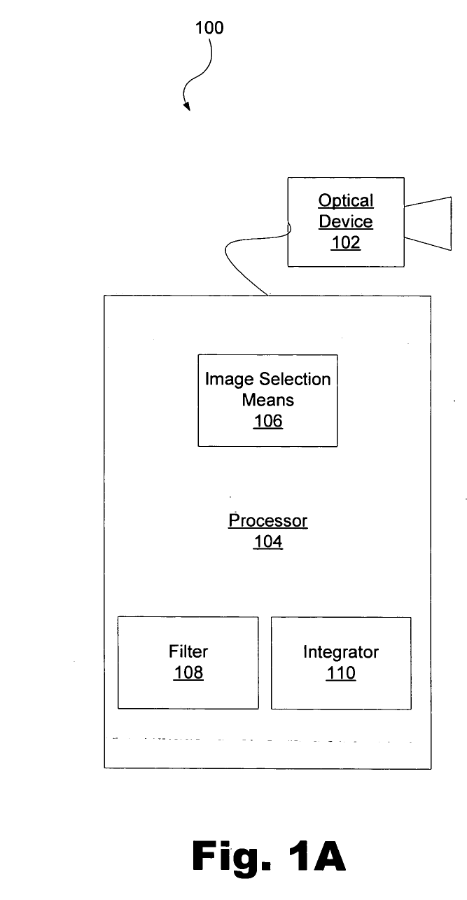

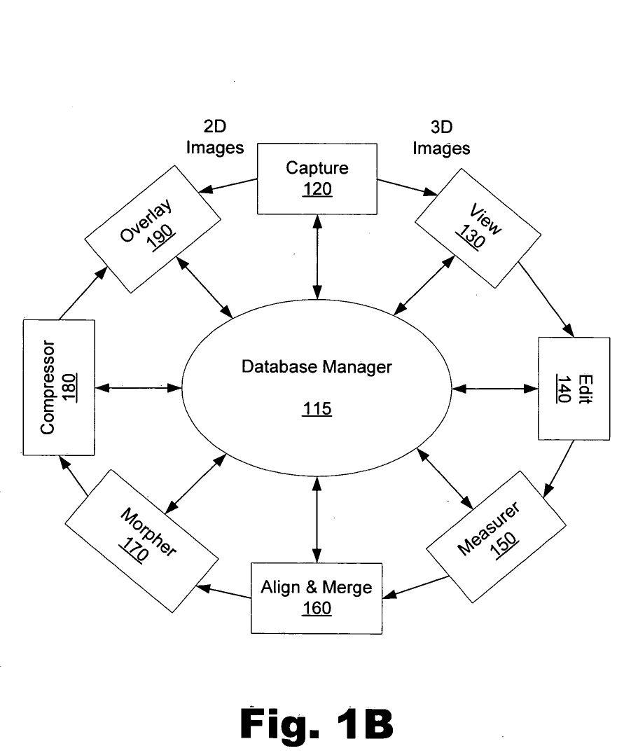

FIG. 1A is a representative block diagram of a 3D imaging system according to one exemplary embodiment. Similarly, FIG. 1B is a simple block diagram illustrating the system interaction components of the modeling system illustrated in FIG. 1A, according to one exemplary embodiment. As can be seen in FIG. 1A, the present exemplary 3D imaging system (100) generally includes a camera or optical device (102) for capturing 3D images and a processor (104) that processes the 3D images to construct a 3D model. According to one exemplary embodiment illustrated in FIG. 1A, the processor (104) includes means for selecting 3D images (106), a filter (108) that removes unreliable or undesirable areas from each selected 3D image, and an integrator (110) that integrates the 3D images to form a mosaic image that, when completed, forms a 3D model. Further details of the above-mentioned exemplary 3D imaging system (100) will be provided below.

The optical device (102) illustrated in FIG. 1A can be, according to one exemplary embodiment, a 3D camera configured to acquire full-frame 3D range images of objects in a scene, where the value of each pixel in an acquired 2D digital image accurately represents a distance from the optical device's focal point to a corresponding point on the object's surface. From this data, the (x,y,z) coordinates for all visible points on the object's surface for the 2D digital image can be calculated based on the optical device's geometric parameters including, but in no way limited to, geometric position and orientation of a camera with respect to a fixed world coordinate, camera focus length, lens radial distortion coefficients, and the like. The collective array of (x,y,z) data corresponding to pixel locations on the acquired 2D digital image will be referred to as a “3D image”.

Often, 3D mosaics are difficult to piece together to form a 3D model because 3D mosaicing involves images captured in the (x,y,z) coordinate system rather than a simple (x,y) system. Often the images captured in the (x,y,z) coordinate system do not contain any positional data for aligning the images together. Conventional methods of 3D image integration rely on pre-calibrated camera positions to align multiple 3D images and require extensive manual routines to merge the aligned 3D images into a complete 3D model. More specifically, traditional systems include cameras that are calibrated to determine the physical relative position of the camera to a world coordinate system. Using the calibration parameters, the 3D images captured by the camera are registered into the world coordinate system through homogeneous transformations. While traditionally effective, this method requires extensive information about the camera's position for each 3D image, severely limiting the flexibility in which the camera's position can be moved.

FIG. 1B illustrates the interaction of an exemplary modeling system, according to one exemplary embodiment. As illustrated in FIG. 1B, the exemplary modeling system is configured to support 3D image acquisition or capture (120), visualization (130), editing (140), measuring (150), alignment and merging (160), morphing (170), compression (180), and texture overlay (190). All of these operations are controlled by the database manager (115).

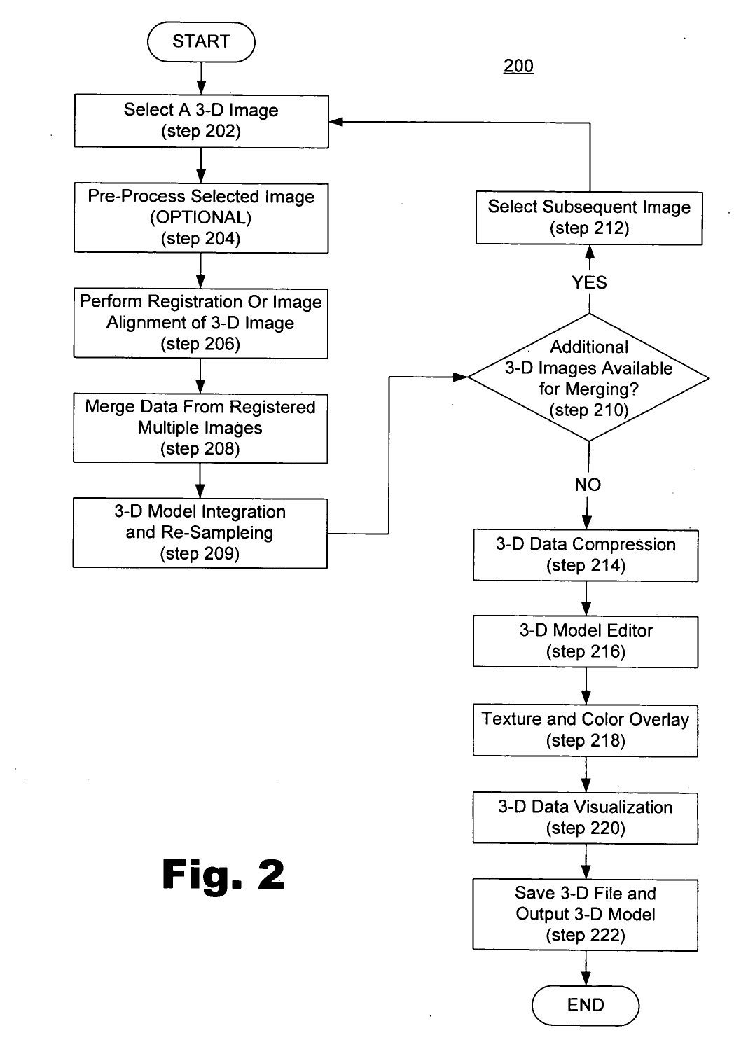

The flowchart shown in FIG. 2 illustrates an exemplary method (step 200) in which 3D images are integrated to form a 3D mosaic and model without the use of position information from pre-calibrated cameras while automatically integrating 3D images captured by any 3D camera. Generally, according to one exemplary embodiment, the present method focuses on initially integrating two 3D images at any given time to form a mosaiced 3D image and then repeating the integration process between the mosaiced 3D image and another 3D image until all of the 3D images forming the 3D model have been incorporated. For example, according to one exemplary embodiment, the present method starts mosaicing a pair of 3D images (e.g., images I₁ and I₂) within a given set of N frames of 3D images. After integrating images I₁ and I₂, the integrated 3D image becomes a new I₁ image that is ready for mosaicing with a third image I₃. This process continues with subsequent images until all N images are integrated into a complete 3D model. This process will be described in greater detail below with reference to FIG. 2.

Image Selection

As illustrated in FIG. 2, the exemplary method (step 200) begins by selecting a 3D image (step 202). The 3D image selected is, according to one exemplary embodiment, a “next best” image. According to the present exemplary embodiment, the “next best” image is determined to be the image that best overlaps the mosaiced 3D image, or if there is no mosaiced 3D image yet, an image that overlaps the other 3D image to be integrated. Selecting the “next best” image allows the multiple 3D images to be matched using only local features of each 3D image, rather than camera positions, to piece each image together in the correct position and alignment.

Image Pre-Processing

Once a 3D image is selected, the selected image then undergoes an optional pre-processing step (step 204) to ensure that the 3D images to be integrated are of acceptable quality. This pre-processing step (step 204) may include any number of processing methods including, but in no way limited to, image filtration, elimination of “bad” or unwanted 3D data from the image, and removal of unreliable or undesirable 3D image data. The pre-processing step (step 204) may also, according to one embodiment, include removal of noise caused by the camera to minimize or eliminate range errors in the 3D image calculation. Noise removal from the raw 3D camera images can be conducted via a spatial average or wavelet transformation process, to “de-noise” the raw images acquired by the camera (102).

A number of noise filters consider only the spatial information of the 3D image (spatial averaging) or both the spatial and frequency information (wavelet decomposition). A spatial average filter is based on spatial operations performed on local neighborhoods of image pixels. The image is convoluted with a spatial mask having a window. The spatial average filter has a zero mean, and the noise power is reduced by a factor equal to the number of pixels in the window. Although the spatial average filter is very efficient in reducing random noise in the image, it also introduces distortion that blurs the 3D image. The amount of distortion can be minimized by controlling the window size in the spatial mask.

Noise can also be removed, according to one exemplary embodiment, by wavelet decomposition of the original image, which considers both the spatial and frequency domain information of the 3D image. Unlike spatial average filters, which convolute the entire image with the same mask, the wavelet decomposition process provides a multiple resolution representation of an image in both the spatial and frequency domains. Because noise in the image is usually at a high frequency, removing the high frequency wavelets will effectively remove the noise.

Image Alignment or Registration

Regardless of which, if any, pre-processing operations are conducted on the selected 3D image, the 3D image then undergoes an image alignment step (step 206). Rather than rely upon camera position information or an external coordinate system, the present system and method relies solely upon the object's 3D surface characteristics, such as surface curvature, to join 3D images together. The 3D surface characteristics are independent of any coordinate system definition or illumination conditions, thereby allowing the present exemplary system and method to produce a 3D model without any information about the camera's position. Instead, according to one exemplary embodiment, the system locates corresponding points in overlapping areas of the images to be joined and performs a 4×4 homogenous coordinate transformation to align one image with another in a global coordinate system.

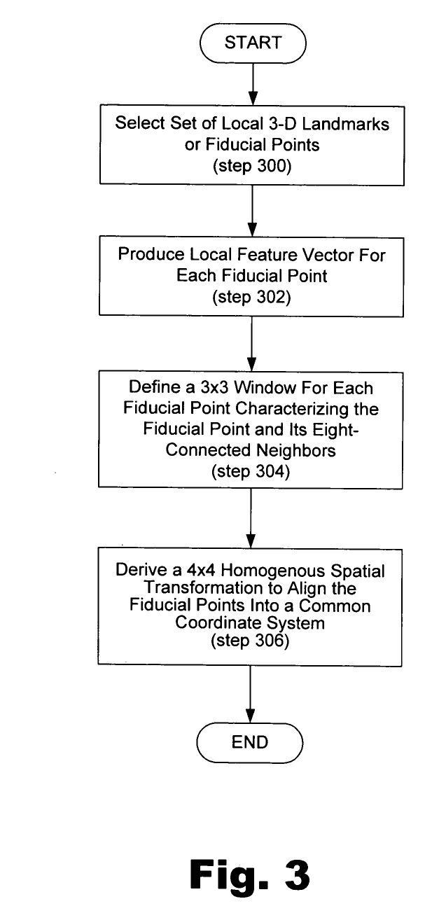

The preferred alignment process will be described with reference to FIGS. 3 through 5. As explained above, the 3D images produced by a 3D camera are represented by arrays of (x, y, z) points that describe the camera's position relative to the 3D surface. Multiple 3D images of an object taken from different viewpoints therefore have different “reference” coordinate systems because the camera is in a different position and/or orientation for each image, and therefore the images cannot be simply joined together to form a 3D model.

Previous methods of aligning two 3D images required knowledge of the relative relationship between the coordinate systems of the two images; this position information is normally obtained via motion sensors. However, this type of position information is not available when the images are obtained from a hand-held 3D camera, making it impossible to calculate the relative spatial relationship between the two images using known imaging systems. Even in cases where position information is available, the information tends to be only an approximation of the relative camera positions, causing the images to be aligned inaccurately.

The present exemplary system provides more accurate image alignment, without the need for any camera position information, by aligning the 3D images based solely on information corresponding to the detected 3D surface characteristics. Because the alignment process in the present system and method does not need any camera position information, the present system and method can perform “free-form” alignment of the multiple 3D images to generate the 3D model, even if the images are from a hand-held camera. This free-form alignment eliminates the need for complex positional calibrations before each image is obtained, allowing free movement of both the object being modeled and the 3D imaging device to obtain the desired viewpoints of the object without sacrificing speed or accuracy in generating a 3D model.

An exemplary way in which the alignment step (step 206) is carried out imitates the way in which humans assemble a jigsaw puzzle in that the present system relies solely on local boundary features of each 3D image to integrate the images together, with no global frame of reference. Referring to FIGS. 3 through 5, geometric information of a 3D image can be represented by a triplet I=(x, y, z). To align a pair of 3D images, the system selects a set of local 3D landmarks, or fiducial points (300), on one image, and defines 3D features for these points that are independent from any 3D coordinate system. The automatic alignment algorithm of the present system and method uses the fiducial points fᵢ, i=0, 1, 2 . . . n, for alignment by locating corresponding fiducial points from the other 3D image to be merged and generating a transformation matrix that places the 3D image pair into a common coordinate system.

A local feature vector is produced for each fiducial point at step (302). The local feature vector responds to a local minimum curvature and/or maximum curvature. The local feature vector for the fiducial point is defined as (k₀₁,k₀₂)^{t}, where k₀₁ and k₀₂ are the minimum and maximum curvature of the 3D surface at the fiducial point, respectively. The details on the computation of the k₀₁ and k₀₂ are given below:
z(x,y)=β₂₀x²+β₁₁x,y+β₀₂y²+β₁₀x+β₀₁y+β₀₀.

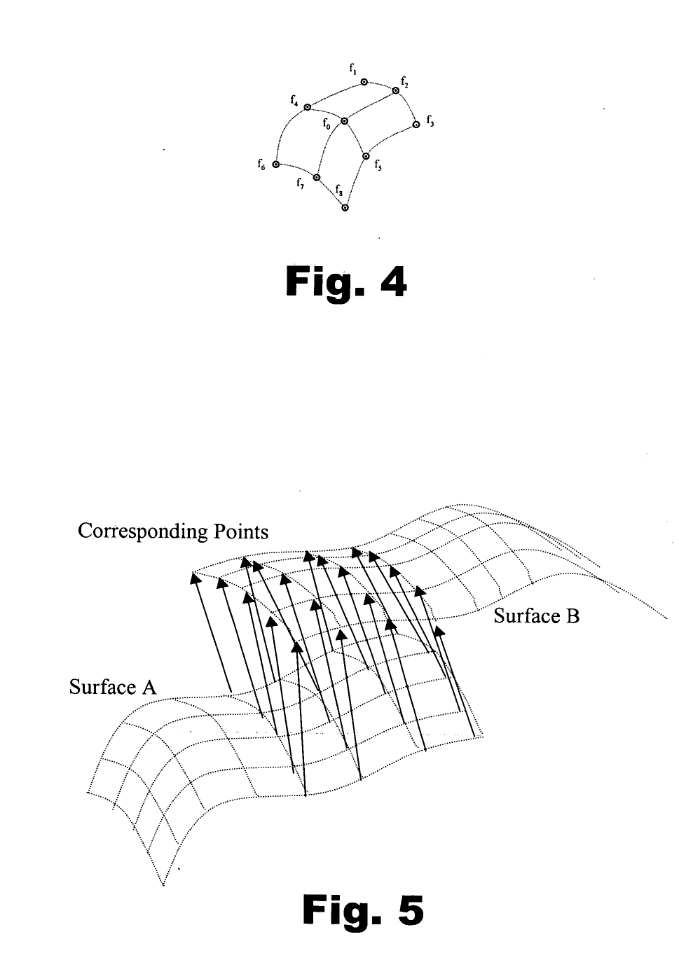

Once a local feature vector is produced for each fiducial point, the method defines a 3×3 window for a fiducial point f₀=(x₀, y₀, z₀), which, according to one exemplary embodiment, contains all of its 8-connected neighbors {f_{w}=(x_{w}, y_{w}, z_{w}), w=1, . . . 8} (step 304), as shown in FIG. 4. The 3D surface is expressed as a second order surface characterization for the fiducial point at f₀ and its 8-connected neighbors (step 304). More particularly, the 3D surface is expressed at each of the 9 points in a 3×3 window centered on as one row in the following matrix expression:

$$[ \begin{matrix}{z}_{0} \\ {z}_{1} \\ {z}_{2} \\ {z}_{3} \\ {z}_{4} \\ {z}_{5} \\ {z}_{6} \\ {z}_{7} \\ {z}_{8}\end{matrix} ] = [ \begin{matrix}{x}_{0}^{2} & {x}_{0} {y}_{0} & {y}_{0}^{2} & {x}_{0} & {y}_{0} & 1 \\ {x}_{1}^{2} & {x}_{1} {y}_{1} & {y}_{1}^{2} & {x}_{1} & {y}_{1} & 1 \\ {x}_{2}^{2} & {x}_{2} {y}_{2} & {y}_{2}^{2} & {x}_{2} & {y}_{2} & 1 \\ {x}_{3}^{2} & {x}_{3} {y}_{3} & {y}_{3}^{2} & {x}_{3} & {y}_{3} & 1 \\ {x}_{4}^{2} & {x}_{4} {y}_{4} & {y}_{4}^{2} & {x}_{4} & {y}_{4} & 1 \\ {x}_{5}^{2} & {x}_{5} {y}_{5} & {y}_{5}^{2} & {x}_{5} & {y}_{5} & 1 \\ {x}_{6}^{2} & {x}_{6} {y}_{6} & {y}_{6}^{2} & {x}_{6} & {y}_{6} & 1 \\ {x}_{7}^{2} & {x}_{7} {y}_{7} & {y}_{7}^{2} & {x}_{7} & {y}_{7} & 1 \\ {x}_{8}^{2} & {x}_{8} {y}_{8} & {y}_{8}^{2} & {x}_{8} & {y}_{8} & 1\end{matrix} ] [ \begin{matrix}{β}_{20} \\ {β}_{11} \\ {β}_{02} \\ {β}_{10} \\ {β}_{01} \\ {β}_{00}\end{matrix} ]$$

or Z=Xβ in vector form, where β=[β₂₀ β₁₁ β₀₂ β₁₀ β₀₁ β₀₀]^{t} is the unknown parameter vector to be estimated. Using the least mean square (LMS) estimation formulation, we can express β in terms of Z and X:
β≈\hat{β}=(X^{t}X)⁻¹X^{t}Z
where (X^{t}X)⁻¹X^{t} is the pseudo inverse for X. The estimated parameter vector \hat{β} is used for the calculations of the curvatures k₁ and k₂. Based on known definitions in differential geometry, k₁ and k₂ are computed based on the intermediate variables, E, F, G, e, f, g:

$$\begin{matrix}E = 1 + {β}_{20}^{2} \\ F = {β}_{10} {β}_{01} \\ G = 1 + {β}_{02}^{2}\end{matrix} \begin{matrix}e = ( 2 {β}_{20} ) / \sqrt{EG - {F}^{2}} \\ f = ( 2 {β}_{11} ) / \sqrt{EG - {F}^{2}} \\ g = ( 2 {β}_{02} ) / \sqrt{EG - {F}^{2}}\end{matrix}$$

The minimum curvature at the point f₀ is defined as:

$${k}_{1} = [ gE - 2 Ff + Ge - \sqrt{{( gE + Ge - 2 Ff )}^{2} - 4 ( eg - {f}^{2} ) ( EG - {F}^{2} )} ] / \begin{matrix}[ 2 ( EG - {F}^{2} ) ]\end{matrix}$$

and the maximum curvature is defined as:

$${k}_{2} = [ gE - 2 Ff + Ge + \sqrt{{( gE + Ge - 2 Ff )}^{2} - 4 ( eg - {f}^{2} ) ( EG - {F}^{2} )} ] / \begin{matrix}[ 2 ( EG - {F}^{2} ) ]\end{matrix}$$

In the preceding equations, k₁ and k₂ are two coordinate-independent parameters indicating the minimum and the maximum curvatures at f₀, and they form the feature vector that represents local characteristics of the 3D surface for the image.

Once each of the two 3D images to be integrated have a set of defined local fiducial points, the present exemplary system derives a 4×4 homogenous spatial transformation to align the fiducial points in the two 3D images into a common coordinate system (step 306). Preferably, this transformation is carried out via a least-square minimization method, which will be described in greater detail below with reference to FIG. 5.

According to the present exemplary method, the corresponding fiducial point pairs on surface A and surface B illustrated in FIG. 5 are called Aᵢ and Bᵢ respectively, where i=1, 2, . . . , n. Surface A and surface B are overlapping surfaces of the first and second 3D images; respectively. In the least-square minimization method, the object is to find a rigid transformation that minimizes the least-squared distance between the point pairs Aᵢ and Bᵢ. The index of the least-squared distance is defined as:

$$I = {\sum }_{i = 1}^{n} {\vert {A}_{i} - R ( {B}_{i} - {B}_{c} ) - T \vert}^{2}$$

where T is a translation vector, i.e., the distance between the centroid of the point Aᵢ and the centroid of the point Bᵢ. R is found by constructing a cross-covariance matrix between centroid-adjusted pairs of points.

In other words, during the alignment step (step 206), the present exemplary method starts with a first fiducial point on surface A (which is in the first image) and searches for the corresponding fiducial point on surface B (which is in the second image). Once the first corresponding fiducial point on surface B is found, the present exemplary method uses the spatial relationship of the fiducial points to predict possible locations of other fiducial points on surface B and then compares local feature vectors of corresponding fiducial points on surfaces A and B. If no match for a particular fiducial point on surface A is found on surface B during a particular prediction, the prediction process is repeated until a match is found. The present exemplary system matches additional corresponding fiducial points on surfaces A and B until alignment is complete.

Note that not all measured points have the same amount of error. For 3D cameras that are based on the structured light principle, for example, the confidence of a measured point on a grid formed by the fiducial points depends on the surface angle with respect to the light source and the camera's line-of-sight. To take this into account, the present exemplary method can specify a weight factor, wᵢ, to be a dot product of the grid's normal vector N at point P and the vector L that points from P to the light source. The minimization problem is expressed as a weighted least-squares expression:

$$I = {\sum }_{i = 1}^{n} {w}_{i} {\vert {A}_{i} - R ( {B}_{i} - {B}_{c} ) - T \vert}^{2}$$

To achieve “seamless” alignment, a “Fine Alignment” optimization procedure is designed to further reduce the alignment error. Unlike the coarse alignment process mentioned above where we derived a closed-form solution, the fine alignment process is an iterative optimization process.

According to one exemplary embodiment, the seamless or fine alignment optimization procedure is performed by an optimization algorithm, which will be described in detail below. As discussed in previous sections, we define the index function:

$$I = {\sum }_{i = 1}^{n} {w}_{i} {\vert {A}_{i} - R ( {B}_{i} - {B}_{c} ) - t \vert}^{2}$$

where R is the function of three rotation angles (α,β,γ), t is a translation vector (x,y,z), and Aᵢ and Bᵢ are the n corresponding sample points on surface A and B respectively.

Rather than using just the selected feature points, as was performed for the coarse alignment, the present exemplary embodiment of the fine alignment procedure uses a large number sample points Aᵢ and Bᵢ in the shared region and calculates the error index value for a given set of R and T parameters. Small perturbations to the parameter vector (α,β,γ,x,y,z) are generated in all possible first order difference, which results in a set of new index values. If the minimal value of this set of indices is smaller than the initial index value of this iteration, the new parameter set is updated and a new round of optimization begins.

During operation of the fine alignment optimization procedure, two sets of 3D images, denoted as surface A and surface B are input to the algorithm along with the initial coarse transformation matrix (R^{(k)}, t^{(k)}) having initial parameter vector (α₀, β₀, γ₀, x₀, y₀, z₀). Once the inputs are received, the algorithm outputs a set of transformation (R′,t′) that aligns A and B. Once the set of transformation (R′, t′) is output, for any given sample point Aᵢ^{(k)} on surface A, the present exemplary method searches for the closest corresponding Bᵢ^{(k)} on surface B, such that distance d=|Aᵢ^{(k)}−Bᵢ^{(k)}| is minimal for all neighborhood points of Bᵢ^{(k)}.

The error index for perturbed parameter vector (αₖ±Δα, βₖ±Δβ, γₖ±Δγ, xₖ±Δx,yₖ±Δy,zₖ±Δz) can then be determined, where (Δα, Δβ, Δγ, Δx, Δy, Δz) are pre-set parameters. By comparing the index values of the perturbed parameters, an optimal direction can be determined. If the minimal value of this set of indices is smaller than the initial index value of this iteration k, the new parameter set is updated and a new round of optimization begins.

If, however, the minimal value of this set of indices is greater than the initial index value of this iteration k, the optimization process is terminated. The convergence of the proposed iterative fine alignment algorithm can be easily proven. Notice that the following equation holds I^{(k+1)}<I^{(k)}, k=1,2, . . . . Therefore the optimization process can never diverge.

Returning to FIG. 2, to increase the efficiency and speed of the alignment step (step 206) the process can incorporate a multi-resolution approach that starts with a coarse grid and moves toward finer and finer grids. For example, the alignment process (step 206) may initially involve constructing a 3D image grid that is one-sixteenth of the full resolution of the 3D image by sub-sampling the original 3D image. The alignment process (step 206) then runs the alignment algorithm over the coarsest resolution and uses the resulting transformation as an initial position for repeating the alignment process at a finer resolution. During this process, the alignment error tolerance is reduced by half with each increase in the image resolution.

According to one exemplary embodiment of the present system and method, a user is allowed to facilitate the registration and alignment (step 206) by manually selecting a set of feature points (minimum three points in each image) in the region shared by a plurality of 3D images. Using the curvature calculation algorithm discussed previously, the program is able to obtain a curvature values from one 3D image and search for the corresponding point on another 3D image that has the same curvature values. The feature points on the second image are thus modified to the points in which the curvature values are calculated and match with the corresponding points from the first image. The curvature comparison process would establish the spatial corresponding relationship among these feature points.

Any inaccuracy in establishing the correspondence of feature points leads to inaccurate estimation of transformation parameters. Consequently, a verification mechanism may be employed, according to one exemplary embodiment, to check the validity of the corresponding feature points founded by the curvature-matching algorithm. Only valid corresponding pairs may then be selected to calculate the transformation matrix.

According to one exemplary embodiment, the distance constraints imposed by rigid transformations may be used as the validation criteria. Given feature points A₁ and A₂ on the surface A and corresponding B₁ and B₂ on the surface B, the following constraint holds for all the rigid transformations:
∥A₁−A₂∥=∥B₁−B₂∥, or δ₁₂ ^{A=δ}₁₂^{B}
Otherwise, the (A₁, A₂) and (B₁, B₂) cannot be valid feature point pair. If the difference between δ₁₂^{A} and δ₁₂^{B} are sufficiently large, 10% of its length, for example, we can reasonably assume that the feature point pair is invalid. In the case where multiple feature points are available, all possible pairs (Aᵢ, Aⱼ) and (Bᵢ, Bⱼ) may be examined, where i, j,=1,2, . . . N. Then the points are ranked according to the most number of incompatible pairs. Then the points are removed according to their ranking on the list.

According to the above-mentioned method, the transformation matrix can be calculated using three feature point pair. Given feature points A₁, A₂ and A₃ on the surface A and corresponding B₁, B₂ and B₃ on the surface B, a transformation matrix can be obtained by first Aligning B₁ with A₁ (via a simple translation), aligning B₂ with A₂ (via a simple rotation around A₁), and aligning B₃ with A₃ (via a simple rotation around A₁A₂ axis). Subsequently combining these three simple transformations will produce an alignment matrix.

In the case where multiple feature points are available, all possible pairs (Aᵢ, Aⱼ, Aₖ) and (Bᵢ, Bⱼ, Bₖ), where i, j, k,=1,2, . . . N would be examined. Subsequently, the transformation matrices are ranked according to an error index

$$( I = {\sum }_{i = 1}^{n} {w}_{i} {\vert {A}_{i} - R ( {B}_{i} - {B}_{c} ) - t \vert}^{2} ) .$$

Then the transformation matrix that produces the minimum error will be selected.

In addition to the above-mentioned registration techniques, a number of alternative 3D registration methods may be employed. According to one exemplary embodiment, an iterative closest point (ICP) algorithm may be performed for 3D registration. The idea of the ICP algorithm is, given two sets of 3D points representing two surfaces called P and X, find the rigid transformation as defined by rotation R and translation T, which minimizes the sum of Euclidean square distances between the corresponding points of P and X. The sum of all square distances gives rise to the following surface matching error:

$$e ( R , T ) = {\sum }_{k}^{N} {‖ ( {Rp}_{k} + T ) - {x}_{k} ‖}^{2} , {p}_{k} ∈ P and {x}_{k} ∈ X .$$

By iteration, optimum R and T values are found to minimize the error e(R, T). In each step of the iteration process, the closest point xₖ on X Of pₖ on P is obtained by effective search structure such as k-D tree partitioning method.

Knowing the calibration information of the 3D camera, based on Pin-hole camera model, the computational intensive 3D searching process will become a 2D searching process on the image plane of the camera. This will save considerable time over traditional ICP algorithm processing, especially when aligning dozens of range images.

The above-mentioned ICP algorithm uses two surfaces that are roughly brought together. Otherwise the ICP algorithm will converge to some local minimum. According to one exemplary embodiment, roughly bringing the two surfaces together can be done by manually selecting corresponding feature points on the two surfaces.

However, in many applications such as the 3D ear camera, automatic registration is desired. According to one exemplary embodiment, feature tracking is performed through a video sequence to construct the correspondence between two 2D images. Subsequently, camera motion can be obtained by known Structure From Motion (SFM) methods. A good feature for tracking is a textured patch with high intensity variation in both x and y directions, such as a corner. Accordingly, the intensity function may be denoted by I(x, y) and the local intensity variation matrix as:

$$Z = [ \begin{matrix}\frac{{\partial }^{2} I}{\partial {x}^{2}} & \frac{{\partial }^{2} I}{\partial x \partial y} \\ \frac{{\partial }^{2} I}{\partial x \partial y} & \frac{{\partial }^{2} I}{\partial {y}^{2}}\end{matrix} ]$$

According to one exemplary embodiment, a patch defined by a 25×25 window is accepted as a candidate feature if in the center of the window both eigenvalues of Z, λ_{1 l and λ}₁, exceed a predefined threshold λ: min(λ₁, λ₂)>λ.

KLT feature tracker is used for tracking good feature points through a video sequence. The KLT feature tracker is based on the early work of Lucas and Kanade as disclosed in Bruce D. Lucas and Takeo Kanade. An Iterative Image Registration Technique with an Application to Stereo Vision, International Joint Conference on Artificial Intelligence, pages 674-679, 1981; as well as Tomasi and Kanade in Jianbo Shi and Carlo Tomas, Good Feature to Track, IEEE Conference on Computer Vision and Pattern Recognition, pages 593-600, 1994, which references are incorporated herein by reference in their entirety. Briefly, good features are located by examining the minimum eigenvalue of each 2 by 2 gradient matrix, and features are tracked using a Newton-Raphson method of minimizing the difference between the two windows.

After having the corresponding feature points on multiple images, 3D scene structure or camera motion from those images can be recovered from the feature correspondence information. According to one exemplary embodiment, approaches for recovering camera or structure motion are taught in Hartley, R. I. [Richard I.] In Defense of the Eight-Point Algorithm, PAMI(19), No. 6, June 1997, pp. 580-593 and Z. Zhang, R. Deriche, O. Faugeras, Q.-T. Luong, “A Robust Technique for Matching Two Uncalibrated Images Through the Recovery of the Unknown Epipolar Geometry”, Artificial Intelligence Journal, Vol.78, pages 87-119, October 1995, which references are incorporated herein by reference in their entirety. However, with the above-mentioned methods, the results are either unstable, need the estimation of ground truth, or only a unit vector of translation T can be obtained.

According to one exemplary embodiment, with the help from 3D surfaces corresponding to 2D images, 3D positions of well-tracked feature points can be used directly for the initial guess of 3D registration.

Alternatively, the 3D image registration process may be fully automatic. That is, with the ICP and automatic feature tracking techniques, the entire process of 3D image registration may be performed by: capturing one 3D surface through a 3D camera; while moving to next position, capturing the video sequence and do feature tracking; capturing another 3D surface at the new position; obtaining the initial guess for the 3D registration from tracked feature points on 2D video; and using the ICP method to refine the 3D registration.

While the above-mentioned method is somewhat automatic, computational efficiency is an important issue in the application of aligning range images. Various data structures are used to facilitate search of the closest point. Traditionally, K-d tree is the most popular data structure for fast closest point search. It is a multidimensional search tree for points in k dimensional space. Levels of the tree are split along successive dimensions at the points. The memory requirement for this structure grows linearly with the number of points and is independent of the number of used features.

However, when dealing with tens of range images with hundreds of thousand 3D points, the k-d tree method becomes less effective, not only due to the performance of k-d tree structure, but also due to the amount of memory used to store this structure of each range image.

Consequently, according to one exemplary embodiment, an exemplary registration method based on the pin-hole camera model is proposed to reduce the memory used and enhance performance. According to the present exemplary embodiment, the 2D closest point search is converted to 1D and has no extra memory requirement.

Previously existing methods (such as K-D Tree) perform registration without taking into consideration of the nature of 3D images, thus they could not take advantage of leveraging known sensor configuration to simplify the calculation. The present exemplary method improves on the speed of traditional image registration methods by incorporating various knowledge user already have about the imaging sensor into the algorithm.

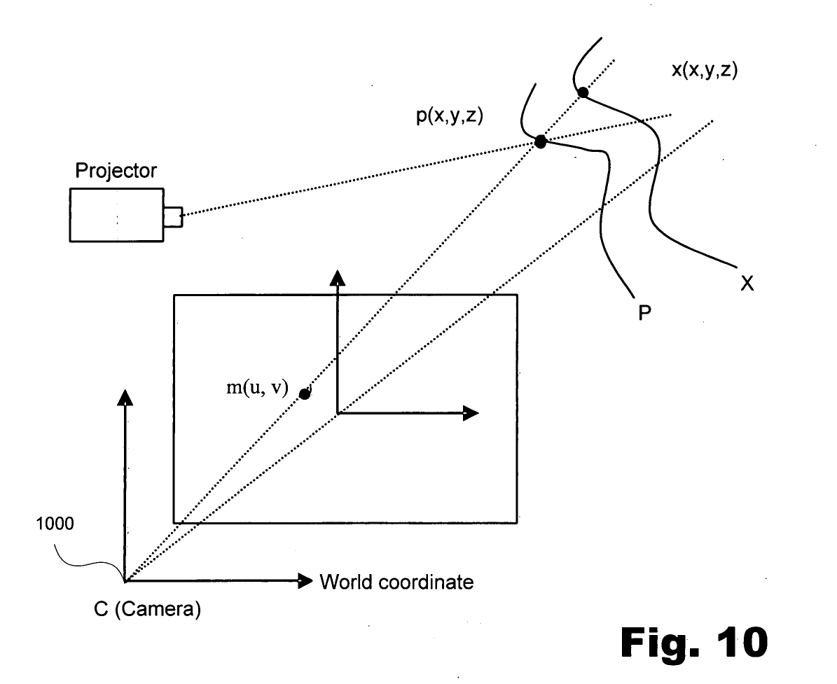

According to the present exemplary method, 3D range images are created from a 3D sensor. Traditionally, a 3D sensor includes one CCD camera and a projector. The camera can be described by widely used pinhole model as illustrated in FIG. 10. As illustrated in FIG. 10, the world coordinate system is constructed on the optical center of the camera (1000). Each 3D point p(x, y, z) on surface P captured by the camera corresponds to a point on the image plane (CCD), shown as m(u, v). The 3D point x(x, y, z) and 2D point m(u, v) are related by the following relationship:

$$s ( \begin{matrix}u \\ v \\ 1\end{matrix} ) = P ( \begin{matrix}x \\ y \\ z \\ 1\end{matrix} ) ,$$

where 5 is an arbitrary scale and P is a 3×4 matrix, called the perspective projection matrix. Consequently, the one-one correspondence of 3D point to 2D point on the image plane can be obtained as mentioned above.

The matrix P can be decomposed as P=A[R, T], where A is a 3×3 matrix, mapping the normalized image coordinates to the retinal image coordinates, and (R, T) is the 3D motion (rotation and translation) from the world coordinate system to the camera coordinate system. The most general matrix A can be written as:

$$A = [ \begin{matrix}- {fk}_{u} & 0 & {u}_{0} \\ 0 & - {fk}_{v} & {v}_{0} \\ 0 & 0 & 1\end{matrix} ] ,$$

where f is the focal length of the camera, kᵤ and kᵥ are the horizontal and vertical scale factors, whose inverses characterize the size of the pixel in the world coordinate unit, u₀ and v₀ are the coordinates of the principal point of the camera, the intersection between the optical axis and the image plan. These parameters called internal and external parameters of camera are known after camera calibration.

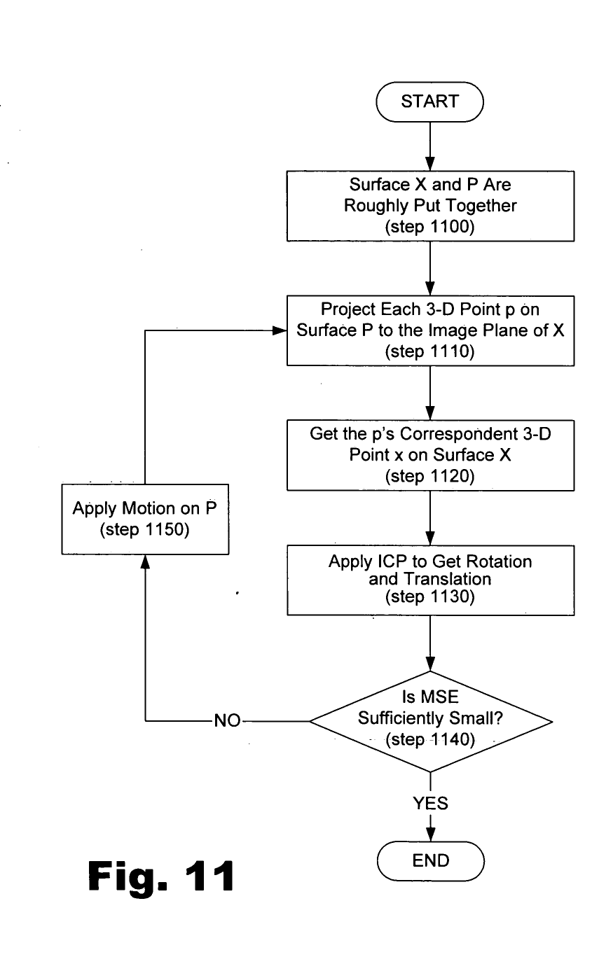

Given another 3D surface P, finding the closest point on surface X corresponding to p(x, y, z) on surface P can be performed. By projecting p(x, y, z) onto the image plane of surface X, m(u, v), a 2D point on the image plane of X, can be calculated as noted above. Meanwhile the correspondence of m(u, v) to 3D point x(x, y, z) is already available because x(x, y, z) is calculated from m(u, v) when doing triangulation. This 3D point x(x, y, z) will be a good estimate of the closest point of p(x, y, z) on surface X. The reason is that ICP method required surface X and surface P be roughly brought together, called initial guess. Due to this good initial estimate, it is acceptable to perform an exhaust search near x(x, y, z) for better accuracy. FIG. 11 illustrates the above-mentioned method, according to one exemplary embodiment.

As illustrated in FIG. 11, the method begins by roughly placing X and P together (step 1100). Once placed together, each 3D point p on surface P is projected onto the image plane of X (step 1110). Once projected, the p's correspondent 3D point x is obtained on surface X (step 1120) and ICP is applied to get rotation and translation (step 1130). Once ICP is applied, it is determined whether the MSE is sufficiently small (step 1140). If the MSE is sufficiently small (YES, step 1140), then the method ends. If, however, the MSE is not sufficiently small (NO, step 1140), then motion is applied to surface P (step 1150) and each 3D point p on surface P is again projected onto the image plane of X (step 1110). It has been shown that the above-mentioned algorithm performs at least 20 times faster than traditional K-D tree based algorithms.

Data Merging

Once the alignment step (step 206) is complete, the present exemplary method merges, or blends, the aligned 3D images to form a uniform 3D image data set (step 208). The object of the merging step (step 208) is to merge the two raw, aligned 3D images into a seamless, uniform 3D image that provides a single surface representation and that is ready for integration with a new 3D image. As noted above, the full topology of a 3D object is realized by merging new 3D images one by one to form the final 3D model. The merging step (step 208) smoothes the boundaries of the two 3D images together because the 3D images usually do not have the same spatial resolution or grid orientation, causing irregularities and reduced image quality in the 3D model. Noise and alignment errors also may contribute to surface irregularities in the model.

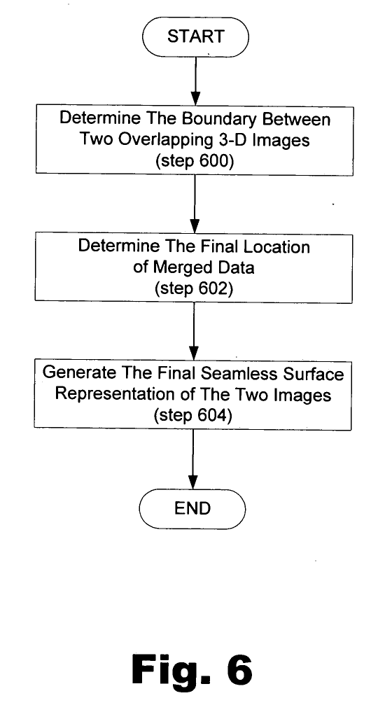

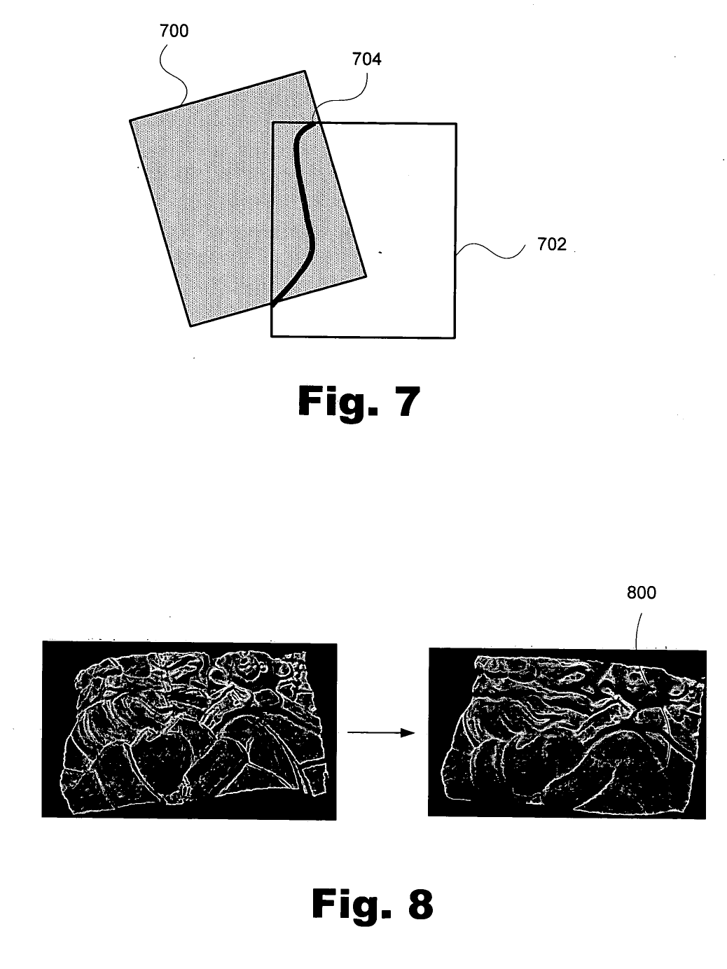

FIG. 6 is a flowchart showing one exemplary method in which the merging step (step 208) can be carried out in the present exemplary method. Further, FIGS. 7 and 8 are diagrams illustrating the merging of 3D images. In one exemplary embodiment illustrated in FIG. 6, multiple 3D images are merged together using fuzzy logic principles and generally includes the steps of determining the boundary between two overlapping 3D images at step (600), using a weighted average of surface data from both images to determine the final location of merged data at step (602), and generating the final seamless surface representation of the two images at step (604). Each one of these steps will be described in further detail below.

For the boundary determination step (600), the present exemplary system can use a method typically applied to 2D images as described in P. Burt and E. Adelson, “A multi-resolution spline with application to image mosaic”, ACM Trans. On Graphics, 2(4):217, 1983, the disclosure of which is incorporated by reference herein. As shown in FIG. 7, given two overlapping 3D images (700, 702) having arbitrary shapes on image edges, the present exemplary system can determine an ideal boundary line (704) where each point on the boundary lies an equal distance from two overlapping edges. In the boundary determination step (600; FIG. 6), 3D distances are used in the algorithm implementation to determine the boundary line (704) shape.

The quality of the 3D image data is also considered in determining the boundary (704). The present exemplary method generates a confidence factor corresponding to a given 3D image, which is based on the difference between the 3D surface's normal vector and the camera's line-of-sight. Generally speaking, 3D image data will be more reliable for areas where the camera's line-of-sight is aligned with or almost aligned with the surface's normal vector. For areas where the surface's normal vector is at an angle with respect to the camera's line of sight, the accuracy of the 3D image data deteriorates. The confidence factor, which is based on the angle between the surface's normal vector and the camera's line-of-sight, is used to reflect these potential inaccuracies.

More particularly, the boundary determining step (600) combines the 3D distance (denoted as “d”) and the confidence factor (denoted as “c”) to obtain a weighted sum that will be used as the criterion to locate the boundary line (704) between the two aligned 3D images (700, 702):
D=w₁d+w₂c
Determining a boundary line (704) based on this criterion results in a pair of 3D images that meet along a boundary with points of nearly equal confidences and distances.

After the boundary determining step, the process smoothes the boundary (700) using a fuzzy weighting function (step 602). As shown in FIG. 8, the object of the smoothing step (602) is to generate a smooth surface curvature transition along the boundary (700) between the two 3D images, particularly because the 3D images may not perfectly match in 3D space even if they are accurately aligned. To remove any sudden changes in surface curvature in the combined surface at the boundary (704) between the two 3D images (700, 702), the present exemplary method system uses a fuzzy weighting average function to calculate a merging surface (800) based on the average location between two surfaces. Specific methodologies to implement the fuzzy weighting average function, which is similar to a fuzzy membership function, are described in Geng, Z. J., “Fuzzy CMAC Neural Networks”, Int. Journal of Intelligent and Fuzzy Systems, Vol. 4, 1995, p. 80-96; and Geng, Z. J and C. McCullough, “Missile Control Using the Fuzzy CMAC Neural Networks”, AIAA Journal of Guidance, Control, and Dynamics, Vol. 20, No. 3, p. 557, 1997, the disclosures of which are incorporated by reference herein. Once the smoothing step (602) is complete, any large jumps between the two 3D images (700, 702) at the boundary area (704) are merged by an average grid that acts as the merging surface (800) and smoothes surface discontinuities between the two images (700, 702).

Re-Sampling

After the smoothing step (602), the exemplary merging method illustrated in FIG. 6 generates a final surface representation of the merged 3D images (step 604). This step (604) can be conducted in several ways, including, but in no way limited to, “stitching” the boundary area between the two 3D images or re-sampling an area that encompasses the boundary area (step 209; FIG. 2). Both methods involve constructing triangles in both 3D images at the boundary area to generate the final surface representation. Note that although the stitching method is conceptually simple, connecting triangles from two different surfaces creates an exponential number of ways to stitch the two surfaces together, making optimization computationally expensive. Further, the simple stitching procedure often creates some visually unacceptable results due to irregularities in the triangles constructed in the boundary area.

Consequently, the re-sampling method (step 209), as illustrated in FIG. 2, is used for generating the final surface representation in one exemplary embodiment of the present system because it tends to generate an even density of triangle vertices. Generally, the re-sampling process (step 209) begins with a desired grid size selection (i.e., an average distance between neighboring sampling points on the 3D surface). Next, a linear or quadratic interpolation algorithm calculates the 3D coordinates corresponding to the sampled points based on the 3D surface points on the original 3D images. In areas where the two 3D images overlap, the fuzzy weighting averaging function described above can be applied to calculate the coordinate values for the re-sampled points. This re-sampling process tends to provide a more visually acceptable surface representation.

Alternatively, after each 3D image has been aligned (i.e., registered) into a same coordinate system, a single 3D surface model can be created from those range images. There are mainly two approaches to generate this single 3D iso-surface model, mesh integration and volumetric fusion as disclosed in Turk, G., M. Levoy, Zippered polygon meshes from range images, Proc. of SIGGRAPH, pp.311-318, ACM, 1994 and Curless, B., M. Levoy, A volumetric method for building complex models from range images, Proc. of SIGGRAPH, pp.303-312, ACM, 1996, both of which are incorporated herein by reference in their entirety.

The mesh integration approach can only deal with simple cases such as where two range images are involved in the overlapping area. Otherwise the situation will be too complicated to build the relationship of those range images and the overlapping area will merge into an iso-surface.

On the contrast, the volumetric fusion approach is a general solution which is suitable for various circumstances. For instance, for full coverage, dozens of range images are to be captured for an ear impression. Quite a few ranges will overlap to each other. The volumetric fusion approach is based on the idea of marching cube which creates a triangular mesh that will approximate the iso-surface.

According to one exemplary embodiment, an algorithm for the marching cube includes: first, locating the surface in a cube of eight vertexes; then assigning outside 0 to vertex outside the surface and 1 to vertex inside the surface; then generating triangles based on surface-cube intersection pattern; and marching to the next cube.

Selecting Additional Images

Continuing with FIG. 2, once the preprocessing, alignment, and merging steps (step 204, 206, 208) are completed to form a new 3D image, the mosaicing process continues by determining if there are additional 3D images associated with the current image are available for merging (step 210). If there are further images available for mergins (YES, step 210), the process continues by selecting a new, “next best” 3D image to integrate (step 212). The new image preferably covers a neighboring area of the existing 3D image and has portions that significantly overlap the existing 3D image for improved results. The process then repeats the pre-processing, alignment and merging steps (step 204, 206, 208) with subsequently selected images (step 212) until all of the “raw” 3D images are merged together to form a complete 3D model.

After the 3D model is complete and it is determined that there are no further images available for merging (NO, step 210), it may be desirable, according to one exemplary embodiment, to compress the 3D model data (step 214) so that it can be loaded, transferred, and/or stored more quickly. As is known in the art and noted above, a 3D model is a collection of geometric primitives that describe the surface and volume of a 3D object. The size of a 3D model of a realistic object is usually quite large, ranging from several megabytes (MB) to several hundred MB files. The processing of such a huge 3D model is very slow, even on the state-of-the-art high-performance graphics hardware.

According to one exemplary embodiment, a polygon reduction method is used as a 3D image compression process in the present exemplary method (step 214). Polygon reduction generally entails reducing the number of geometric primitives in a 3D model while minimizing the difference between the reduced and the original models. A preferred polygon reduction method also preserves important surface features, such as surface edges and local topology, to maintain important surface characteristics in the reduced model.

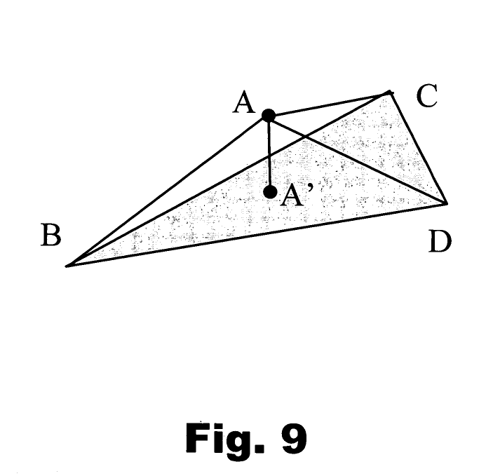

More particularly, an exemplary compression step (step 214) used in the present exemplary method involves using a multi-resolution triangulation algorithm that inputs the 3D data file corresponding to the 3D model and changes the 3D polygons forming the model into 3D triangles. Next, a sequential optimization process iteratively removes vertices from the 3D triangles based on an error tolerance selected by the user. For example, in dental applications, the user may specify a tolerance of about 25 microns, whereas in manufacturing applications, a tolerance of about 0.01 mm would be acceptable. A 3D distance between the original and reduced 3D model, as shown in FIG. 9, is then calculated to ensure the fidelity of the reduced model.

As can be seen in FIG. 9, the “3D distance” is defined as the distance between a removed vertex (denoted as point A in the FIG.) in the original 3D model and an extrapolated 3D point (denoted as point A′) in the reduced 3D model. A′ is on a plane formed by vertices B, C, D in a case when a linear extrapolation method is used. Once this maximum 3D distance among all the removed points exceeds a pre-specified tolerance level, the compression step (step 214) will be considered complete.

The present exemplary method may continue by performing post-processing steps (step 216, 218, 220, 222) to enhance and preserve the image quality of the 3D model. These post-processing steps can include, but are in no way limited to any miscellaneous 3D model editing functions (step 216), such as retouching the model, or overlaying the 3D model with a 2D texture/color overlay (step 218) to provide a more realistic 3D representation of an object. Additionally, texture overlay technique may provide an effective way to reduce the number of polygons in a 3D geometry model while preserve a high level of visual fidelity of 3D objects. In addition to the 3D model editing functions (step 216) and the texture/color overlay (step 218), the present exemplary method may also provide a graphical 3D data visualization option (step 220) and the ability to save and/or output the 3D model (step 222). The 3D visualization tool allows users to assess the 3D Mosaic results and extract useful parameters from the completed 3D model. Additionally, the 3D model may be output or saved on any number of storage or output mediums.

According to one exemplary embodiment, the present system and method are graphically illustrated by an interactive graphical user interface (GUI) to ensure the ease of use and streamlining process of 3D image acquisition, processing, alignment/merge, compression, and transmission. The GUI would allow user to have a full control of the process while maintain its intuitiveness and speed.

According to one exemplary embodiment, the GUI and its associated components and software contain software drivers for acquiring images using various CCD cameras, both analog and digital, while handling both monochromic and color image sensors. Using the GUI and its associated software, the various properties of captured images may be controlled including, but in no way limited to, resolution (number of pixels such as 240 by 320, 640 by 480, 1040 by 1000, etc.); color(binary, 8-bit monochromic, 9-bit, 15-bit, or 24 bit RGB color, etc.); acquisition speed (30 frames per second (fps), 15 pfs, free-running, user specified, etc.); file format (tiff, bmp, and many other popular 2D image formats and conversion utilities among these file formats).

Additionally, according to one exemplary embodiment, the GUI and its associated software may be used to display and manipulate 3D models. According to one exemplary embodiment, the software is written in C++ using Open-GL library under the WINDOWS platform. According to this exemplary embodiment, the GUI and its associated software are configured to: first, provide multiple viewing windows controlled by users to simultaneously view the 3D object from different perspectives; second, manipulate one or more 3D objects on the screen, such manipulation including, but not limited to, rotation around and translation along three spatial axes to provide full six degrees of freedom manipulation capabilities, zoom in/out, automatic centering and scaling the displayed 3D object to fit the screen size, and multiple resolution display during the manipulation in order to improve the speed of operation; third, set material properties, display and color modes for optimized rendering results including, but in no way limited to, multiple rendering mode including surface, point of cloud, mesh, smoothed surface, and transparency; short-cut key for frequently used functions; and online documentation. Additionally, the pose of each 3D image can be changed in all degrees of freedom of translation/rotation with a three-key mouse or other similar input device.

According to another exemplary embodiment, the GUI interface and its associated software may be used to clean up received 3D image data. According to this exemplary embodiment, the received 3D images are interpolated on a square parametric grid. Once interpolated, the bad 3D data can be determined based on bad viewing angle of optical and light devices, lack of continuity of received data based on a threshold distance, and/or Za and Zb constraints.

Further, using iterative minimum distance algorithms, the software associated with the present system and method is configured to determine via a trial and error method the transformation matrix that can minimize the registration error defined and the sum of distances between corresponding points on a plurality of 3D surfaces. According to the present exemplary embodiment, the software initiates several incremental transformation matrices, and find a best one that can minimize the registration error, in each iteration. Such an incremental matrix will approach to identification matrix if the iterative optimization process converges.

Applications

According to one exemplary embodiment, the above-mentioned system and method are used to form a 3D model of dental prosthesis for CAD/CAM-based restoration. While traditional dental restorations rely upon physical impression to obtain precise shape of the complex dental surface, the present 3D dental imaging technique eliminates traditional dental impressions and provide accurate 3D model of dental structures.

According to one exemplary embodiment, digitizing dental casts for building crowns and other dental applications includes taking five 3D images from five views (top, right, left, upper and lower sides). These images are pre-processed to eliminate “bad points” and imported to the above-mentioned alignment software which conducts both the “coarse” and the “fine” alignment procedures. After obtaining the alignment transformations for all five images, the boundary detection is performed and unwanted portions of 3D data from the original images are cut off. The transformation matrices are then used to align these processed images together.

Once the source image is transformed using the spatial transformation determined by the alignment process, in most cases, only parts of the multiple images are overlapped. Therefore the error is calculated only in the overlapping regions. In general, the alignment error is primarily determined by two factors: the noise level in the original 3D images, and accuracy of the alignment error.

According to one exemplary embodiment, the 3D dental model is sent to commercial dental prosthesis vendors to have an actual duplicated dental part made using high-precision milling machine. The duplicated part, as well as the original tooth model, is then sent to a calibrated touch-probe 3D digitization machine to measure the surface profiles. The discrepancy between the original tooth model and the duplicated part are within acceptable level (<25 microns) for dental restoration applications.

Additionally, the present system and method may be used in plastic surgery applications. According to one exemplary embodiment, the above-mentioned system and method may be implemented for use in plastic surgery planning, evaluation, training, and documentation.

Human body is a complex 3D object. The quantitative 3D measurement data enables plastic surgeons to perform high-fidelity pre-surgical prediction, post-surgical monitoring, and computer-aided procedure design. The 2D and 3D images captured by the 3D video camera would allow the surgeon and the patient to discuss the surgical planning process through the use of actual 2D/3D images and computer-generated alternations. Direct preoperative visual communication helps to increase postoperative satisfaction by improving patient education in regards to realistic results. The 3D visual communication may also be invaluable in resident and fellow teaching programs between attending and resident surgeons.

In some plastic surgery applications, such as breast augmentation and facial surgeries, single view 3D images provide sufficient quantitative information for the intended applications. However, for other clinical cases such as breast reduction, due to the extreme size of the breast, multiple 3D images from different viewing angles are needed to cover entire region.

Applying the procedures of pre-processing and coarse/fine alignment with our prototype software, three 3D images can be merged into a complete breast model. These breast models may then be used for pre-operative evaluation, surgical planning, and patient communications. According to one exemplary embodiment, the differences in volume measurements between actual breast size and image breast size have been confirmed to be less than 3%, which is acceptable for clinical applications for the breast reduction surgery.

Further, the present system and method may be used for enhancing reverse engineering techniques. According to one exemplary embodiment, where there is a high dimensional accuracy request, 3D images may be taken and merged according to the above-mentioned methods.

However, there are often very few surface features that help the alignment of multiple 3D images—the surface are all smooth and with similar shape. In such cases the object may be fixed onto a background that has rich set of features allowing for the free-form alignment program work properly. The inclusion of dents or surface variations help the alignment program greatly in finding the corresponding point in the overlapping regions of 3D images. Once the images of the desired object are aligned properly, the 3D images may be further processed to cut off the background regions and generate a set of cleaned images.

Alternatively, better correspondence can be found if the surface contains more discriminative characteristics. One possible solution to such a situation is to use additional information, such as surface color, to differentiate the surface features. Another solution is to use additional features outside the object to serve as alignment “bridge points”.

The integration module of the 3D Mosaic prototype software is then used to fuse the 3D images together. Additionally, the 3D model compression program may be used to obtain 3D models with 50K, 25K, 10K and 5K triangles.

It should be understood that various alternatives to the embodiments of the present exemplary system and method described herein may be employed in practicing the present exemplary system and method. It is intended that the following claims define the scope of the invention and that the system and method within the scope of these claims and their equivalents be covered thereby.

1. A method for three-dimensional (3D) modeling of a 3D surface, comprising:
obtaining a plurality of uncalibrated 3D images;
selecting a pair of 3D images out of said plurality of uncalibrated 3D images;
integrating said pair of 3D images to form a mosaiced image; and
repeating said integrating step by integrating said mosaiced image and a subsequent 3D image selected from said plurality of uncalibrated 3D images until a 3D model is completed.

2. The method of claim 1, wherein the step of integrating said pair of 3D images comprises:
filtering said pair of 3D images to remove unwanted areas of said 3D images;
aligning said pair of 3D images in a selected global coordinate system; and
merging said pair of 3D images to form said mosaiced image.

3. The method of claim 2, wherein said aligning step conducts alignment based on a surface feature that is independent from a coordinate system definition or an illumination condition.

4. The method of claim 2, wherein said merging step comprises blending a boundary between said pair of 3D images.

5. The method of claim 4, wherein said subsequent 3D image selected from said plurality of uncalibrated 3D images comprises a 3D image that overlaps said mosaiced image and covers an area of said 3D surface adjacent to an area of said 3D surface covered by said mosaiced image.

6. The method of claim 2, wherein said aligning step comprises:
selecting a first set of fiducial points on a first of said pair of 3D images;
selecting a second set of fiducial points on a second of said pair of 3D images, wherein said first and second sets of fiducial points correspond to overlapping portions of said pair of 3D images; and
aligning corresponding fiducial points between said first and second sets of fiducial points to join said pair of 3D images to form said mosaiced image.

7. The method of claim 6, wherein said step of aligning the corresponding fiducial points comprises deriving a spatial transformation matrix via a least squares minimization method to align the pair of 3D images into a common coordinate system.

8. The method of claim 4, wherein said blending comprises:
determining a boundary area between overlapping portions of said pair of 3D images;
smoothing said boundary area using a fuzzy weighting averaging function; and
conducting a re-sampling operation by sampling a plurality of points on the 3D surface and calculating 3D coordinates using an interpolation algorithm on the sampled points.

9. The method of claim 1, further comprising compressing said 3D model via an image compression process.

10. The method of claim 9, wherein said compressing conducts compression via a multi-resolution triangulation algorithm, which includes the steps of:
expressing the 3D model as 3D polygons;
converting the 3D polygons from the expressing step into 3D triangles;
iteratively removing triangulation vertices from the 3D triangles to generate a reduced 3D model; and
calculating a 3D distance between the 3D model and the reduced 3D model.

11. The method of claim 1, further comprising the step of overlaying a two-dimensional (2D) texture/color overlay over the 3D model.

12. An apparatus for three-dimensional (3D) modeling of a 3D surface, comprising:
an optical device configured to obtain a plurality of uncalibrated 3D images that include data corresponding to a distance between a focal point of the optical device and a point on the 3D surface; and
a processor coupled to the optical device that includes:
a selector that selects a pair of 3D images out of said plurality of uncalibrated 3D images obtained by said optical device; and
an integrator configured to integrate said pair of 3D images to form a mosaiced image,
wherein said integrator repeats said integration process by integrating the mosaiced image and a subsequent 3D image selected from said plurality of uncalibrated 3D images until a 3D model is completed.

13. The apparatus of claim 12, wherein the processor further includes a filter configured to remove undesired areas of said 3D images before the integrator integrates the 3D images.

14. The apparatus of claim 12, wherein the integrator integrates the 3D images by aligning the pair of 3D images in a selected global coordinate system based on a surface feature that is independent from a coordinate system definition and merges the pair of 3D images to form the mosaiced image.

15. The apparatus of claim 12, wherein said integrator is configured to integrate said 3D images by:
selecting a first set of fiducial points on a first of said pair of 3D images;
selecting a second set of fiducial points on said second of said pair of 3D images, wherein said first and second sets of fiducial points correspond to overlapping portions of said pair of 3D images; and
aligning corresponding fiducial points between said first and second sets of fiducial points to join the pair of 3D images to form the mosaiced image.

16. The apparatus of claim 15, wherein the integrator aligns the corresponding fiducial points by deriving a spatial transformation matrix via a least square minimization method to align the pair of 3D images into a common coordinate system.

17. The apparatus of claim 15, wherein the integrator blends a boundary between 3D images by:
determining a boundary area between overlapping portions of the pair of 3D images;
smoothing the boundary area using a fuzzy weighting averaging function; and
conducting a re-sampling operation by sampling a plurality of points on the 3D surface and calculating 3D coordinates using an interpolation algorithm on the sampled points.

18. The apparatus of claim 12, wherein the processor further comprises a compressor configured to compresses data corresponding to the 3D model.

19. The apparatus of claim 18, wherein said compressor is configured to conduct compression via a multi-resolution triangulation algorithm by:
expressing the 3D model as 3D polygons;
converting the 3D polygons into 3D triangles;
iteratively removing triangulation vertices from the 3D triangles to generate a reduced 3D model; and
calculating a 3D distance between the 3D model and the reduced 3D model.

20. The apparatus of claim 12, further comprising an overlay mechanism configured to overlay said 3D model with a two-dimensional (2D) texture/color overlay.

21. An automated computer process for generating a mosaic of a 3D object from a plurality of uncalibrated 3D images comprising the steps of:
capturing a plurality of 3D data images of surfaces of an object or scene from a number of viewpoints;
automatically aligning said plurality of 3D data images into a selected coordinate system based on parameters of a 3D camera utilized to capture said 3D data images; and
merging said plurality of aligned 3D data images into a single 3D geometric model.

22. The computer process of claim 21 wherein said automatically aligning comprises a step of aligning 3D image planes each plane including thousands of 3D points to facilitate a closest point search on a first of said planes with a selectable point on a second of said image planes.

23. The computer process of claim 22 wherein the alignment step comprises a pinhole mathematical matrix step to convert a 2D closest point on a selected one of planes with a 3D point on another selected data plane.

24. The computer process of claim 23 wherein said pinhole mathematical matrix step comprises converting a 2D closest point search on a selected one of said 3D image planes into a 1D point search wherein a point P may be mathematically expressed as:
$$s ( \begin{matrix}u \\ v \\ 1\end{matrix} ) = P ( \begin{matrix}x \\ y \\ z \\ 1\end{matrix} )$$
wherein s is an arbitrary scale factor and P is a perspective projection matrix.

25. The computer process of claim 24 wherein for said pinhole mathematical camera model, the value of P may be mathematically expressed as:
P=A[R,T]
where A is a matrix to map a normalized image coordinate to a retinal image coordinates of a 3D camera and (R,T) is a 3DM matrix for translating relative and translation values for a generalized world coordinate system to the recording camera coordinate system.

26. The computer process of claim 21 wherein said automatic aligning is based upon mathematical matrix utilizing constants of a 3D camera configured to capture said 3D images.

27. The computer process of claim 26 further comprising calibrating said 3D camera to derive at least a plurality of constants to be used in a pinhole mathematical camera model.

28. The computer process of claim 27 wherein said step of calibrating said 3D camera further comprises determining a group of physical characteristics of said 3D camera including coordinates of said camera intersection of optical axis and image plane.

29. A computer modeling apparatus for generating a 3D mosaic from a plurality of uncalibrated 3D surface images comprising:
a 3D camera; and
a 3D modeling computer processor for merging said 3D surface images into a single 3D geometric model
wherein said 3D modeling computer processor is configured to execute a plurality of 3D data surface images to search a plurality of uncalibrated images, to facilitate a data point search to identify and locate closest data points on selected ones of said 3D surface images, and to facilitate alignment of said uncalibrated 3D surface images.

30. The 3D computer modeling apparatus of claim 29 further comprising a computer aligning processor configured to align said plurality of uncalibrated 3D images into a selected coordinate system.
